(19) United States
(12) Patent Application Publication
(10) Pub. No.: US 2026/0061237 A1
(43) Pub. Date: Mar. 5, 2026

(54) BATTERY STRUCTURE

(71) Applicant: HYUNDAI MOBIS CO., LTD., Seoul (KR)

(72) Inventor: Seung Hoon HAN, Yongin-si (KR)

(73) Assignee: HYUNDAI MOBIS CO., LTD., Seoul (KR)

(21) Appl. No.: 19/209,208

(22) Filed: May 15, 2025

(30) Foreign Application Priority Data
Sep. 3, 2024 (KR) 10-2024-0119234

(51) Int. Cl. A62C 3/16; A62C 37/08; H01M 10/613; H01M 10/63; H01M 10/653; H01M 10/6568; H01M 50/213; H01M 50/271

(52) U.S. Cl. CPC A62C 3/16; A62C 37/08; H01M 10/613; H01M 10/63; H01M 10/653; H01M 10/6568; H01M 50/213; H01M 50/271; H01M 2200/10; H01M 2200/20

(57) ABSTRACT

A battery structure includes a plurality of battery cells including electrodes and separators; a casing part defining an internal space configured to accommodate the battery cells; a piping line having a flow path formed therein, the piping line being connected to one side of the casing part; and a fluid storage part connected to one side of the piping line and configured to store an electrically insulative fire extinguishing fluid. The piping line is configured to deliver the fire extinguishing fluid from the fluid storage part into the internal space of the casing part in response to a thermal or pressure condition within the casing part.

### CROSS-REFERENCE TO RELATED APPLICATION

This application claims the benefit under 35 U.S.C. § 119(a) of Korean Patent Application No. 10-2024-0119234 filed on Sep. 3, 2024 in the Korean Intellectual Property Office, the entire disclosure of which is incorporated herein by reference for all purposes.

### BACKGROUND ART

### 1. Field

The present disclosure relates to a battery structure, and more particularly, to a battery structure capable of extinguishing a fire in the event of thermal runaway.

### 2. Discussion of Related Art

A casing of a battery pack, in which a plurality of batteries are mounted, needs to be durable enough to withstand thermal runaway in the battery even in the event of the thermal runaway. Meanwhile, in the event of thermal runaway in the battery in the battery pack, the casing may be deformed by a rapid increase in pressure in the casing. The deformation of the casing causes a situation in which thermal energy generated by gases and fire in the casing is rapidly discharged to the outside.

Therefore, there is a need for a means capable of quickly extinguishing a fire occurring in the casing in the event of thermal runaway in the battery in the battery pack. In particular, in case that the battery pack is mounted in a mobility vehicle such as an electric vehicle, there is a special need for rapid extinguishment of a fire caused by thermal runaway in view of a large energy capacity of the battery pack mounted in the mobility vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure has been made in an effort to provide a means capable of quickly extinguishing a fire caused by thermal runaway in the event of the thermal runaway in a battery structure including a battery pack.

In one general aspect, a battery structure including: a plurality of battery cells including electrodes and separators; a casing part defining an internal space configured to accommodate the plurality of battery cells; a piping line having a flow path formed therein, the piping line being connected to one side of the casing part; and a fluid storage part connected to one side of the piping line and configured to store an electrically insulative fire extinguishing fluid. The piping line is configured to deliver the fire extinguishing fluid from the fluid storage part into the internal space of the casing part in response to a thermal or pressure condition within the casing part.

The piping line may include: an inlet piping line configured to connect the fluid storage part and the casing part; and an outlet piping line configured to connect the casing part and an exterior of the casing part. The outlet piping line may be configured to discharge gas or excess fluid generated inside the casing part externally.

The battery structure may further include: a valve member provided in the inlet piping line and configured to control and open or close a flow path in the inlet piping line; a gas detection member provided in the casing part and configured to detect a gas in the casing part; and a control member connected to the gas detection member and configured to control and open or close the valve member by receiving a signal from the gas detection member.

The battery structure may further include: a level detection member provided in the casing part and configured to detect a level of the fire extinguishing fluid in the casing part. The control member may be configured to receive a signal, which is related to the level of the fire extinguishing fluid in the casing part, from the level detection member.

The battery cell may include an electrolyte, and the gas detection member may be configured to detect a gas generated when the electrolyte vaporizes. In response to a concentration of the gas in the casing part exceeding a predetermined value, the gas detection member may be configured to transmit a signal to the control member, such that the control member may operate to control the valve member.

The inlet piping line and the outlet piping line may be disposed physically apart from each other to form separate flow paths.

The outlet piping line may branch off from the inlet piping line to form a bypass flow path.

The battery structure may further include a fracturable member provided at one side of the inlet piping line, configured to close the inlet piping line, and configured to fracture when a pressure in the inlet piping line reaches a predetermined threshold.

The fracturable member may include a notch region having a smaller thickness than other portions of the fracturable member.

The fire extinguishing fluid may include or be made of a fluoroketone-based material.

The battery structure may further include: a cover part coupled to one side of the casing part; and sealing members provided between the casing part and the cover part. The sealing members may include first and second sealing members provided separately from each other. A direction in which the casing part and the cover part face each other with the first sealing member interposed therebetween, and a direction in which the casing part and the cover part face each other with the second sealing member interposed therebetween, intersect each other.

The casing part may have a first recessed region having a recessed shape, the cover part may have a second recessed region having a recessed shape, the first sealing member may be seated in the first recessed region, and the second sealing member may be seated in the second recessed region.

The cover part may have a flat shape in a region in which the first sealing member is in contact with the cover part, and the casing part may have a flat shape in a region in which the second sealing member is in contact with the casing part.

In another general aspect, a method of controlling fire suppression in a battery structure including a plurality of battery cells accommodated in a casing part, the method including: determining, by a gas detection member provided in the casing part, whether a concentration of a gas in the casing part exceeds a predetermined threshold; transmitting, by the gas detection member, a signal to a control member in response to the concentration of the gas in the casing part exceeding the predetermined threshold; transmitting, by the control member, a control signal to open a valve member provided in an inlet piping line connected to a fluid storage part, such that the control member operates to control the valve member in response to receiving the signal from gas detection member; and supplying, through the inlet piping line, an electrically insulative fire extinguishing fluid stored in the fluid storage part into the casing part to suppress ignition.

The gas detection member may detect the gas generated by vaporization of an electrolyte contained in the battery cells.

The method may further include: detecting, by a level detection member provided in the casing part, a level of the fire extinguishing fluid in the casing part after the valve member is opened; and transmitting, by the level detection member, a level signal to the control member. The control member may determine whether the fire extinguishing fluid has been supplied to a predetermined level based on the level signal.

According to the present disclosure, it is possible to quickly extinguish a fire caused by thermal runaway in the event of the thermal runaway in the battery structure including the battery pack.

Other features and aspects will be apparent from the following detailed description, the drawings, and the claims.

### BRIEF DESCRIPTION OF THE DRAWINGS

FIG. 1 is a top plan view of a battery structure according to the present disclosure.

FIG. 2 is a first schematic view of a battery structure according to a first embodiment of the present disclosure.

FIG. 3 is a second schematic view of the battery structure according to the first embodiment of the present disclosure.

FIG. 4 is a first schematic view of a battery structure according to a second embodiment of the present disclosure.

FIG. 5 is a second schematic view of the battery structure according to the second embodiment of the present disclosure.

FIG. 6 is a first schematic view of a battery structure according to a third embodiment of the present disclosure.

FIG. 7 is a second schematic view of the battery structure according to the third embodiment of the present disclosure.

FIG. 8 is a view illustrating an example of a fracturable member provided in the battery structure of the present disclosure in a state made before the fracturable member is fractured.

FIG. 9 is a view illustrating an example of the fracturable member provided in the battery structure of the present disclosure in a state made after the fracturable member is fractured.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

Hereinafter, a battery structure according to the present disclosure will be described.

### Battery Structure

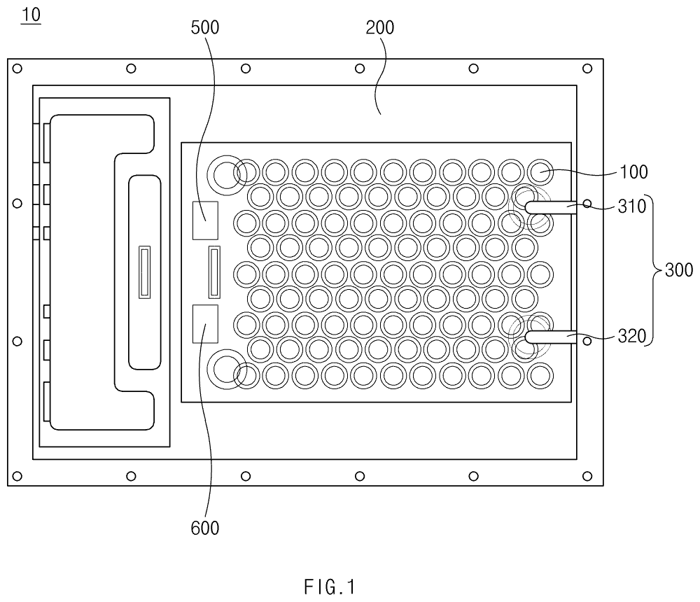

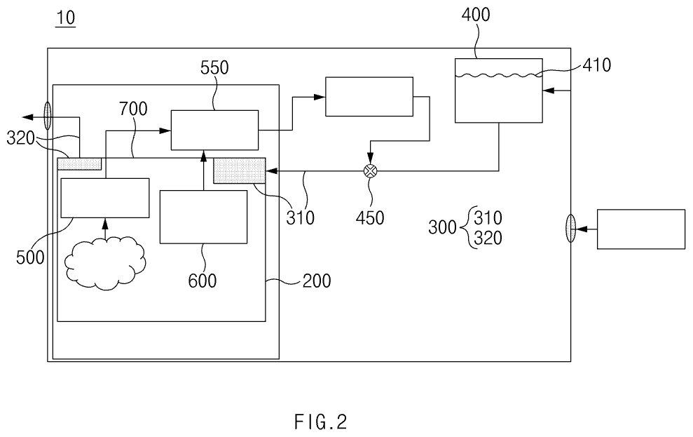

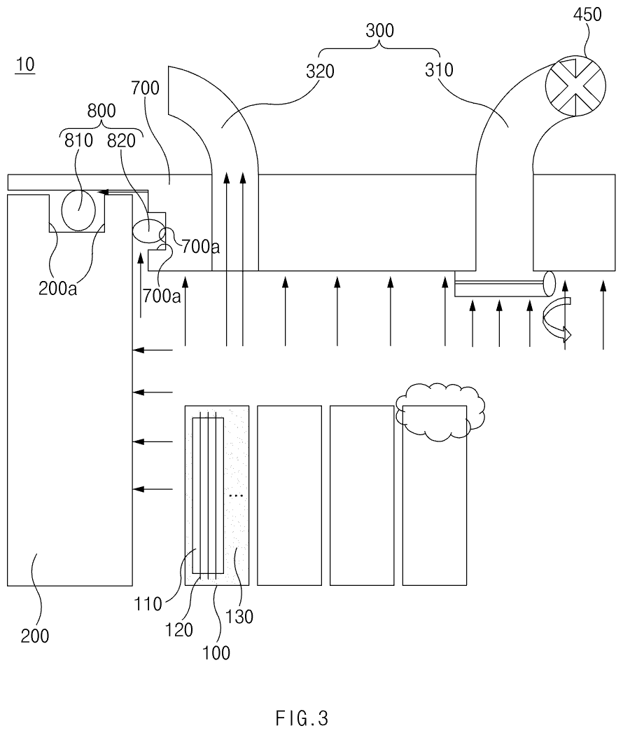

FIG. 1 is a top plan view of a battery structure according to the present disclosure. FIG. 2 is a first schematic view of a battery structure according to a first embodiment of the present disclosure, and FIG. 3 is a second schematic view of the battery structure according to the first embodiment of the present disclosure.

With reference to FIGS. 1 to 3, a battery structure 10 according to the present disclosure may include battery cells 100 including electrodes 110 and separators 120. In addition, the battery structure 10 may further include a casing part 200 having an internal space configured to accommodate the battery cells 100. The battery cells 100 may be accommodated in the internal space of the casing part 200.

Meanwhile, the battery structure 10 according to the present disclosure may further include a configuration capable of extinguishing a fire when the fire occurs in the event of thermal runaway in some of the plurality of battery cells 100.

More specifically, the battery structure 10 may further include a piping line 300 connected to one side of the casing part 200 and having therein a flow path, and a fluid storage part 400 connected to one side of the piping line 300 and configured to store an electrically insulative fire extinguishing fluid 410 therein. According to the present disclosure, in case that a fire occurs in the event of thermal runaway in some of the plurality of battery cells 100, the fire extinguishing fluid 410 in the fluid storage part 400 may be supplied to the internal space of the casing part 200 through the piping line 300, such that the fire may be extinguished. For example, the fire extinguishing fluid 410 may include or be made of a fluoroketone-based material.

Meanwhile, the piping line 300 provided in the battery structure 10 may include an inlet piping line 310 configured to connect the fluid storage part 400 and the casing part 200, and an outlet piping line 320 configured to connect the casing part 200 and the outside of the casing part 200. More specifically, the inlet piping line 310 may define a flow path through which the fire extinguishing fluid 410 is supplied to the internal space of the casing part 200, and the outlet piping line 320 may define a flow path through which the fluid in the internal space of the casing part 200 is discharged to the outside.

With continued reference to FIGS. 2 and 3, the battery structure 10 according to the first embodiment of the present disclosure may further include a valve member 450 provided in the inlet piping line 310 and configured to control and open or close the flow path in the inlet piping line 310, and a gas detection member 500 provided in the casing part 200 and configured to detect a gas in the casing part 200. More specifically, the valve member 450 may be opened or closed to adjust whether to supply the fire extinguishing fluid 410 in the fluid storage part 400 to the internal space of the casing part 200 and adjust a flow rate of the fire extinguishing fluid 410. The gas detection member 500 may detect the gas that increases in amount when a fire occurs in the event of thermal runaway in the battery cell 100. For example, the battery cell 100 may further include an electrolyte 130, and the gas detection member 500 may detect a gas generated when the electrolyte 130 vaporizes.

Meanwhile, according to the first embodiment of the present disclosure, the battery structure 10 may further include a control member 550 connected to the gas detection member 500 and configured to control and open or close the valve member 450 or control an opening degree of the valve member 450 by receiving a signal from the gas detection member 500. For example, the control member 550 may be a battery management system (BMS) member. The control member 550, which receives the signal from the gas detection member 500, may control and open or close the valve member 450 or control the opening degree of the valve member 450 by means of a computer member. More specifically, in case that a concentration of the gas in the casing part 200 exceeds a predetermined value, the gas detection member 500 may transmit a signal to the control member 550, such that the control member 550 may control and open the valve member 450.

With continued reference to FIGS. 2 and 3, the battery structure 10 according to the first embodiment of the present disclosure may further include a level detection member 600 provided in the casing part 200 and configured to detect a level of the fire extinguishing fluid 410 in the casing part 200. In this case, the above-mentioned control member 550 may receive a signal, which is related to the level of the fire extinguishing fluid 410 in the casing part 200, from the level detection member 600. Therefore, according to the first embodiment of the present disclosure, in case that the level of the fire extinguishing fluid 410 in the casing part 200 exceeds a predetermined value, the level detection member 600 may transmit a signal to the control member 550, and the control member 550 may control and close the valve member 450. Therefore, according to the present disclosure, the valve member 450 is closed, such that the supply of the fire extinguishing fluid 410 into the casing part 200 may be cut off.

Meanwhile, according to the first embodiment of the present disclosure, the inlet piping line 310 and the outlet piping line 320 may be physically spaced apart from each other. It is understood that a region in which the fire extinguishing fluid 410 is supplied to the internal space of the casing part 200 and a region in which the fluid, such as the gas, is discharged from the casing part 200 to the outside are physically spaced apart from each other.

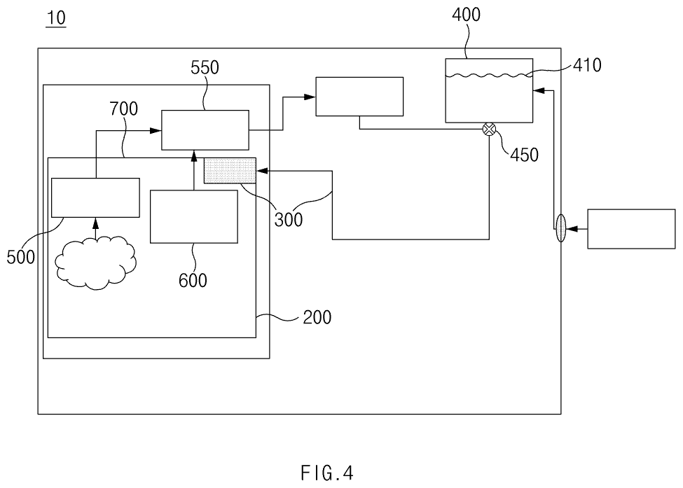

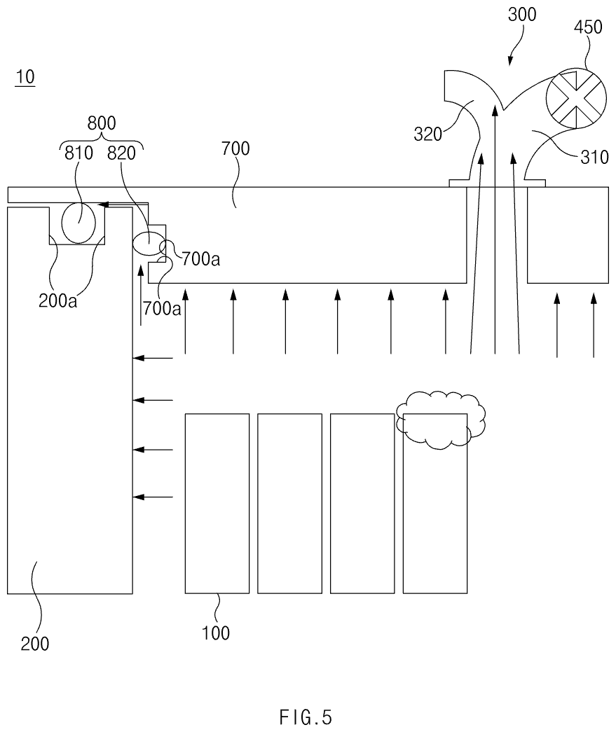

FIG. 4 is a first schematic view of a battery structure according to a second embodiment of the present disclosure, and FIG. 5 is a second schematic view of the battery structure according to the second embodiment of the present disclosure.

The above-mentioned description of the battery structure 10 according to the first embodiment of the present disclosure may also be applied to the battery structure 10 according to the second embodiment of the present disclosure in the same way. However, the second embodiment of the present disclosure differs from the first embodiment of the present disclosure in that the inlet piping line 310 and the outlet piping line 320 are not physically spaced apart from each other.

More specifically, according to the second embodiment of the present disclosure, the outlet piping line 320 may be connected to one side of the inlet piping line 310 and branch off from the inlet piping line 310.

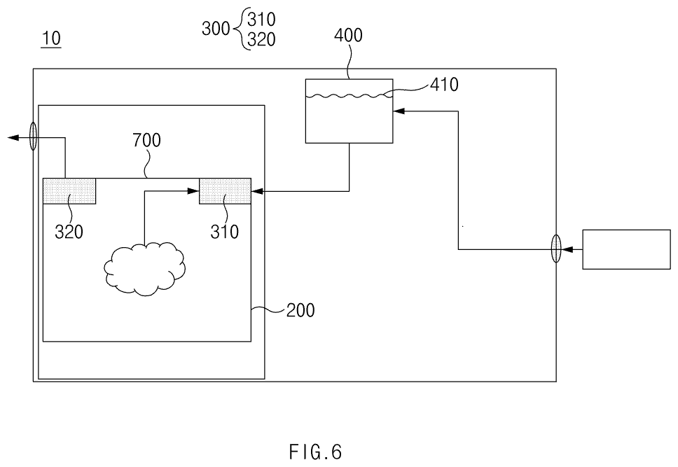

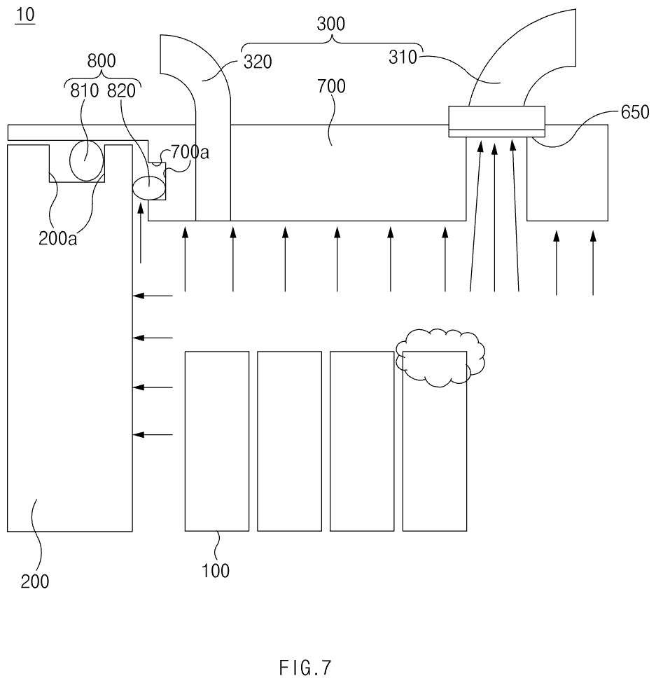

FIG. 6 is a first schematic view of a battery structure according to a third embodiment of the present disclosure, and FIG. 7 is a second schematic view of the battery structure according to the third embodiment of the present disclosure.

The battery structure 10 according to the third embodiment of the present disclosure is identical to those in the first and second embodiments of the present disclosure in that the battery structure 10 may include the battery cells 100, the casing part 200, the piping line 300 including the inlet piping line 310 and the outlet piping line 320, and the fluid storage part 400 configured to store the fire extinguishing fluid 410. However, the battery structure 10 according to the third embodiment of the present disclosure may differ from those in the first and second embodiments of the present disclosure in that the battery structure 10 includes a configuration configured to be physically fractured when pressure in the casing part 200 increases so that the inlet piping line 310 is opened.

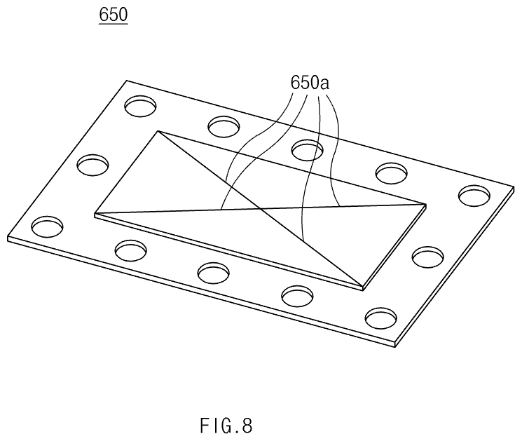

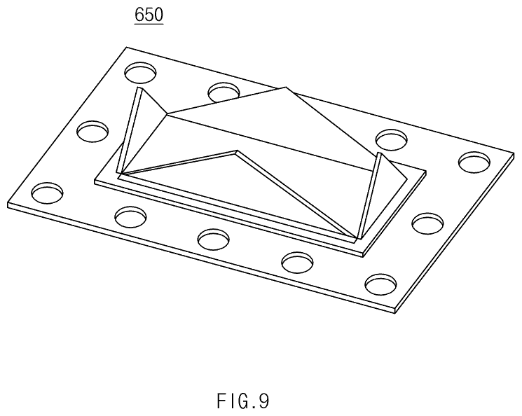

FIG. 8 is a view illustrating an example of a fracturable member provided in the battery structure of the present disclosure in a state made before the fracturable member is fractured, and FIG. 9 is a view illustrating an example of the fracturable member provided in the battery structure of the present disclosure in a state made after the fracturable member is fractured.

More specifically, with reference to FIGS. 6 to 8, according to the third embodiment of the present disclosure, the battery structure 10 may further include a fracturable member 650 provided at one side of the inlet piping line 310 and configured to close the inlet piping line 310. However, the fracturable member 650 may be configured to be fractured in case that predetermined pressure or higher is applied. According to the third embodiment of the present disclosure, in case that the fracturable member 650 is fractured, the inlet piping line 310 is opened, such that the fire extinguishing fluid 410 in the fluid storage part 400 may be introduced into the internal space of the casing part 200 through the inlet piping line 310.

Meanwhile, the fracturable member 650 may include notch regions 650a having a smaller thickness than the other portions of the fracturable member 650. Therefore, in case that pressure applied to the fracturable member 650 exceeds the predetermined value, the notch region 650a, which has relatively low durability, is fractured, such that the inlet piping line 310 may be opened. For example, as illustrated in FIGS. 8 and 9, the notch regions 650a may define an ‘X’ shape.

Meanwhile, according to the present disclosure, the fluid storage part 400 may be provided above the casing part 200 and the inlet piping line 310. In this case, the fire extinguishing fluid 410 in the fluid storage part 400 may be smoothly supplied to the casing part 200 by gravity.

Meanwhile, with reference to FIGS. 3, 5, and 7, the battery structure 10 according to the present disclosure may further include a cover part 700 coupled to one side of the casing part 200. FIGS. 3, 5, and 7 illustrate states in which the cover part 700 is coupled to an upper side of the casing part 200.

In addition, the battery structure 10 may further include sealing members 800 provided between the casing part 200 and the cover part 700. The sealing member 800 may be configured to improve sealability of the internal space of the casing part 200 and configured to prevent the fire extinguishing fluid 410 from leaking to the outside. For example, the sealing member 800 may be an O-ring.

Meanwhile, according to the present disclosure, the sealing members 800 may include first and second sealing members 810 and 820 provided separately from each other. In this case, according to the present disclosure, a direction in which the casing part 200 and the cover part 700 face each other with the first sealing member 810 interposed therebetween and a direction in which the casing part 200 and the cover part 700 face each other with the second sealing member 820 interposed therebetween may intersect each other. More particularly, the direction in which the casing part 200 and the cover part 700 face each other with the first sealing member 810 interposed therebetween and the direction in which the casing part 200 and the cover part 700 face each other with the second sealing member 820 interposed therebetween may perpendicularly intersect each other. For example, FIGS. 3, 5, and 7 illustrate states in which the casing part 200 and the cover part 700 face each other in a vertical direction with the first sealing member 810 interposed therebetween, whereas the casing part 200 and the cover part 700 face each other in a horizontal direction with the second sealing member 820 interposed therebetween.

Meanwhile, the casing part 200 may have a first recessed region 200a having a recessed shape, and the cover part 700 may have a second recessed region 700a having a recessed shape. In this case, the first sealing member 810 may be seated in the first recessed region 200a, and the second sealing member 820 may be seated in the second recessed region 700a. In addition, for example, the cover part 700 may have a flat shape in a region in which the first sealing member 810 is in contact with the cover part 700, and the casing part 200 may have a flat shape in a region in which the second sealing member 820 is in contact with the casing part 200.

Meanwhile, the first and second embodiments according to the present disclosure may be applied together with the third embodiment of the present disclosure. For example, the battery structure 100 according to the present disclosure may have a structure to which the first and third embodiments are applied together or have a structure to which the second and third embodiments are applied together.

Meanwhile, the battery structure according to the present disclosure may be mounted in mobility vehicles such as electric vehicles. Therefore, according to the present disclosure, it is possible to quickly extinguish a fire caused by thermal runaway in the event of the thermal runaway in the battery structure in the mobility vehicle, thereby remarkably improving the safety of the mobility vehicle.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery structure comprising:
a plurality of battery cells comprising electrodes and separators;
a casing part defining an internal space configured to accommodate the plurality of battery cells;
a piping line having a flow path formed therein, the piping line being connected to one side of the casing part; and
a fluid storage part connected to one side of the piping line and configured to store an electrically insulative fire extinguishing fluid,
wherein the piping line is configured to deliver the fire extinguishing fluid from the fluid storage part into the internal space of the casing part in response to a thermal or pressure condition within the casing part.

2. The battery structure of claim 1, wherein the piping line comprises:
an inlet piping line configured to connect the fluid storage part and the casing part; and
an outlet piping line configured to connect the casing part and an exterior of the casing part,
wherein the outlet piping line is configured to discharge gas or excess fluid generated inside the casing part externally.

3. The battery structure of claim 2, further comprising:
a valve member provided in the inlet piping line and configured to control and open or close a flow path in the inlet piping line;
a gas detection member provided in the casing part and configured to detect a gas in the casing part; and
a control member connected to the gas detection member and configured to control and open or close the valve member by receiving a signal from the gas detection member.

4. The battery structure of claim 3, further comprising:
a level detection member provided in the casing part and configured to detect a level of the fire extinguishing fluid in the casing part,
wherein the control member is configured to receive a signal, which is related to the level of the fire extinguishing fluid in the casing part, from the level detection member.

5. The battery structure of claim 3,
wherein the battery cell comprises an electrolyte, and the gas detection member is configured to detect a gas generated when the electrolyte vaporizes, and
wherein, in response to a concentration of the gas in the casing part exceeding a predetermined value, the gas detection member is configured to transmit a signal to the control member, such that the control member operates to control the valve member.

6. The battery structure of claim 2,
wherein the inlet piping line and the outlet piping line are disposed physically apart from each other to form separate flow paths.

7. The battery structure of claim 2,
wherein the outlet piping line branches off from the inlet piping line to form a bypass flow path.

8. The battery structure of claim 2, further comprising:
a fracturable member provided at one side of the inlet piping line, configured to close the inlet piping line, and configured to fracture when a pressure in the inlet piping line reaches a predetermined threshold.

9. The battery structure of claim 8,
wherein the fracturable member comprises a notch region having a smaller thickness than other portions of the fracturable member.

10. The battery structure of claim 1,
wherein the fire extinguishing fluid includes or is made of a fluoroketone-based material.

11. The battery structure of claim 1, further comprising:
a cover part coupled to one side of the casing part; and
sealing members provided between the casing part and the cover part,
wherein the sealing members comprise first and second sealing members provided separately from each other, and
wherein a direction in which the casing part and the cover part face each other with the first sealing member interposed therebetween, and a direction in which the casing part and the cover part face each other with the second sealing member interposed therebetween, intersect each other.

12. The battery structure of claim 11,
wherein the casing part has a first recessed region having a recessed shape, the cover part has a second recessed region having a recessed shape, the first sealing member is seated in the first recessed region, and the second sealing member is seated in the second recessed region.

13. The battery structure of claim 12,
wherein the cover part has a flat shape in a region in which the first sealing member is in contact with the cover part, and the casing part has a flat shape in a region in which the second sealing member is in contact with the casing part.

14. A method of controlling fire suppression in a battery structure comprising a plurality of battery cells accommodated in a casing part, the method comprising: determining, by a gas detection member provided in the casing part, whether a concentration of a gas in the casing part exceeds a predetermined threshold;
transmitting, by the gas detection member, a signal to a control member in response to the concentration of the gas in the casing part exceeding the predetermined threshold;
transmitting, by the control member, a control signal to open a valve member provided in an inlet piping line connected to a fluid storage part, such that the control member operates to control the valve member in response to receiving the signal from gas detection member; and
supplying, through the inlet piping line, an electrically insulative fire extinguishing fluid stored in the fluid storage part into the casing part to suppress ignition.

15. The method of claim 14,
wherein the gas detection member detects the gas generated by vaporization of an electrolyte contained in the battery cells.

16. The method of claim 14, wherein the method further comprises:
detecting, by a level detection member provided in the casing part, a level of the fire extinguishing fluid in the casing part after the valve member is opened; and
transmitting, by the level detection member, a level signal to the control member,
wherein the control member determines whether the fire extinguishing fluid has been supplied to a predetermined level based on the level signal.
